(19) United States
(12) Patent Application Publication
(10) Pub. No.: US 2003/0188617 A1
(43) Pub. Date: Oct. 9, 2003

(54) Gutter punch

(76) Inventor: Wayne A. Willert, Port Washington, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/400,350

(22) Filed: Mar. 27, 2003

Related U.S. Application Data
(60) Provisional application No. 60/368,731, filed on Mar. 29, 2002.

(51) Int. Cl. B26F 1/14

(52) U.S. Cl. 83/687; 83/690; 83/691

(57) ABSTRACT

A gutter punch device is positioned over the water collecting opening of the gutter and is adapted to punch the front and rear sheet metal portions of the gutter. The punched holes are made prior to the hanging of the gutter and are used to receive the gutter fastener for securing the gutter to the fascia board of the structure. The gutter punch can be a double throw or single throw device and enables perfect alignment of the front and rear mounting holes for gutters in an easily reproducible manner.

### CROSS REFERENCE TO RELATED APPLICATIONS

This application claims priority from U.S. provisional patent application serial No. 60/368,731 filed Mar. 29, 2002.

### BACKGROUND OF THE INVENTION

1. Field of the Invention

The present invention relates to gutters, and more particularly, it relates to a gutter punch device for punching holes in the front and rear of the gutter for the gutter fasteners.

2. Description of the Prior Art

Generally, gutters are fastened to structures using aluminum nails or spikes. These nails or spikes are hammered through the front and rear of the gutter in order to attach the gutter to the structure.

Recently, there has been a trend to replace the aluminum nails/spikes with elongated screws. These elongated screws are not capable of being hammered through the front and rear sheet metal of the gutter without damaging either the screw or gutter. As such, it is necessary to punch or drill pilot holes in the front and rear sheet metal portions of the gutter in order to allow the screw to pass there through.

The punching or drilling of pilot holes in the gutter is difficult, if not impossible to perform when the gutter is in the air and being attached to the structure. As such, these pilot holes must be made while the gutter is on the ground.

In order for the pilot holes to function properly, it is preferred that they be perfectly aligned with each other such that the threaded gutter fastener passes through the front and back of the gutter such that it is substantially perpendicular to both the front and back of the gutter (i.e. transverse to the water collecting opening in the top of the gutter).

### SUMMARY OF THE INVENTION

It is therefore desired to provide a gutter punch tool capable of reproducibly punching fastener pilot holes in the front and rear of a gutter prior to installation.

It is also desired to provide a gutter punch tool that is easy to use and allows for substantially perfect axial alignment of the front and rear fastener pilot holes.

These and other desired functions are achieved in accordance with an embodiment of the invention wherein the gutter punch includes a body having a front gutter receiving opening and a rear gutter receiving opening, a throw arm pivotally connected to the body and having an upper end and a lower end, a front punch connected to the lower end of said throw arm and extending into the front gutter receiving opening, and a rear punch connected to said lower end of the throw arm and extending into the front gutter receiving opening.

When the throw arm is moved, it causes at least one of the front punch and the rear punch to engage and punch a hole in the gutter disposed in the respective gutter receiving opening.

In accordance with various aspects of the invention, the gutter punch can be a double throw device or a single throw device. In the double throw embodiment, movement of the throw arm in a first direction causes one of the front punch and the rear punch to punch a hole in the gutter disposed in the respective gutter receiving opening, while movement in an opposing second direction will cause the other of the front punch and rear punch to punch a hole in the gutter disposed in the respective gutter receiving opening.

In the single throw embodiment, the lower end of the throw arm includes an eccentric curved surface and one of the front punch or the rear punch is slidably connected to the eccentric curved surface such that movement of the throw arm in a direction opposite the curved surface simultaneously actuates said front punch and said rear punch. The eccentric curved surface is designed such that the simultaneous actuation of the front and rear punches results in a sequential punching action to the front and rear of the gutter disposed in the front and rear gutter receiving openings.

Adjustable positioning elements are included and connected to the body of the punch device. The adjustable positioning elements aide the user in positioning the gutter in the gutter receiving openings and preventing damage to the gutter when disposed in said gutter receiving openings. The positioning elements facilitate accurate reproducible positioning of the punched holes along the gutter length.

### BRIEF DESCRIPTION OF THE DRAWINGS

In the drawings wherein like reference numerals denote similar components throughout the views:

FIG. 1 is a plan view of the gutter punch according to an embodiment of the invention;

FIG. 2 is a multiple angle plan view of the throw arm of the gutter punch according to an embodiment of the invention;

FIG. 3 is a plan view of the gutter punch in one operable position according to an embodiment of the invention;

FIG. 4 is a plan view of the gutter punch in one operable position according to an embodiment of the invention;

FIG. 5 is a plan view of the gutter punch according to another embodiment of the invention; and

FIG. 6 is a plan view of a punch and rail of the throw arm according to an embodiment of the invention.

### DETAILED DESCRIPTION OF PREFERRED EMBODIMENTS

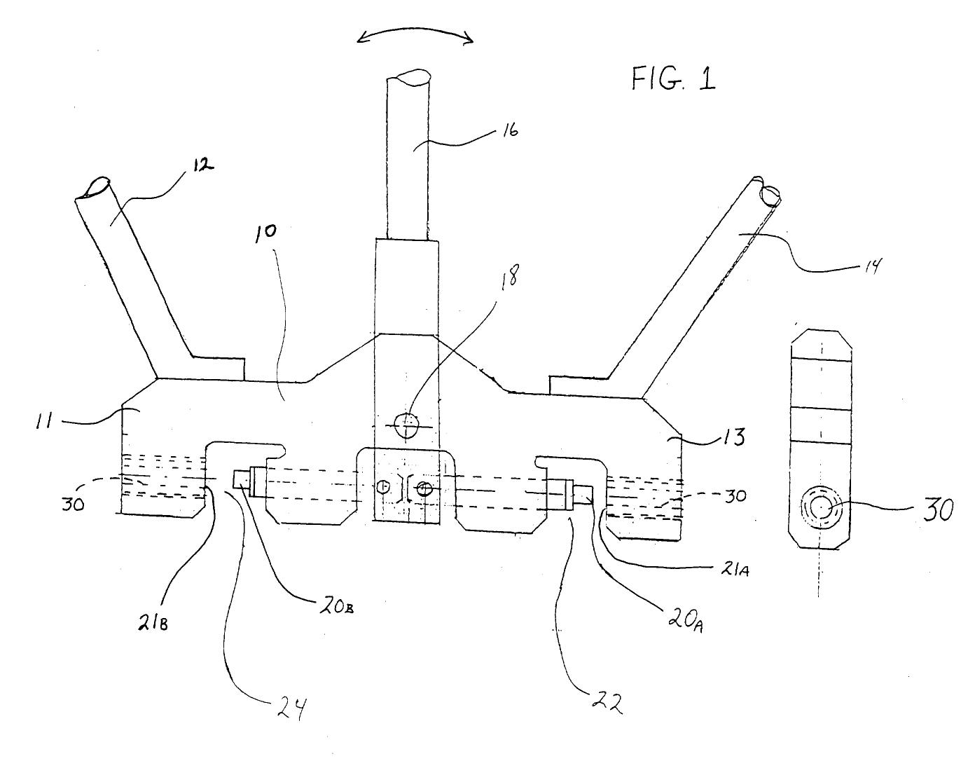

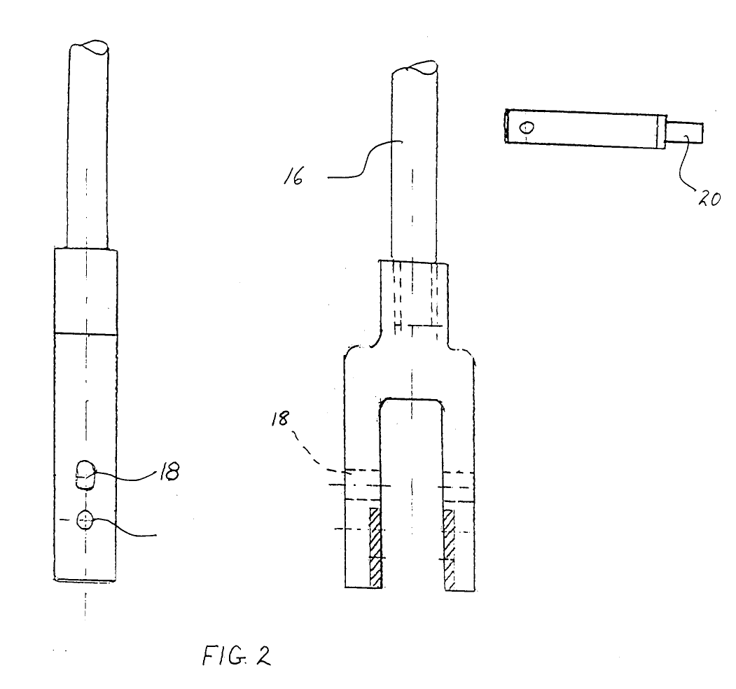

Referring to FIGS. 1-4, the gutter punch 10 includes a body portion with handles 12 and 14 and a throw arm 16. Throw arm 16 is pivotally connected to body 10 at a pivot point 18. Handles 12 and 14 enable the user to securely hold onto punch 10 while performing the punching operation.

The body 10 includes a front portion 13 having a gutter opening 22 and a rear portion 11 having a rear gutter opening 24. Body 10 is positioned over the water collecting top of the gutter and openings 22 and 24 receive both the front and rear, respectively, of the gutter simultaneously. Punches 20a and 20b are hingedly connected to the base of throw arm 16 and extend into the front and rear opening 22 and 24, respectively. When throw arm 16 is moved in one of the two possible directions, punches 20a and 20b engage the sheet metal of the gutter (not shown) and penetrates the same by pressing it against the inner surface 21a and 21b and forcing the sheet metal punch to be ejected through a waste port 30 on each end of body 10. Those of ordinary skill will recognize that the size of the punched hole is dependent on the size of the fastener being used. It is preferred that that the punched hole be slightly larger than the diameter of the fastener to allow for expansion and contraction of the gutter due to changing environment conditions.

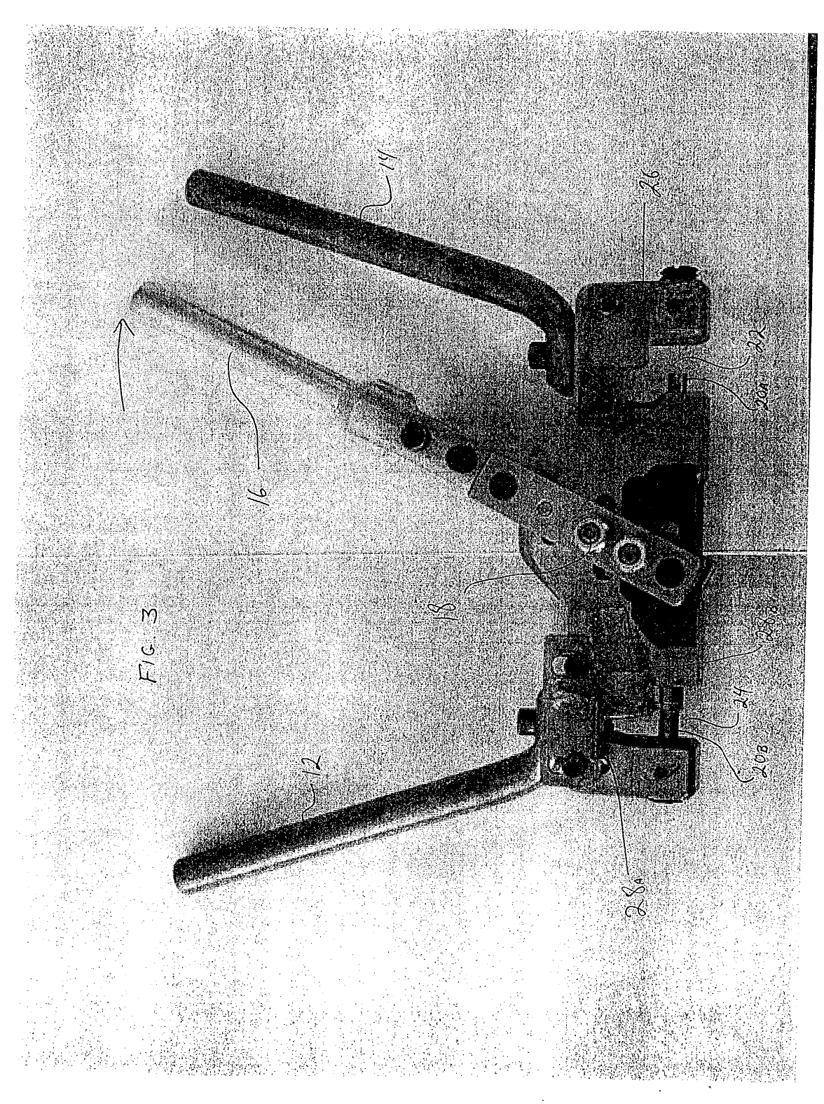

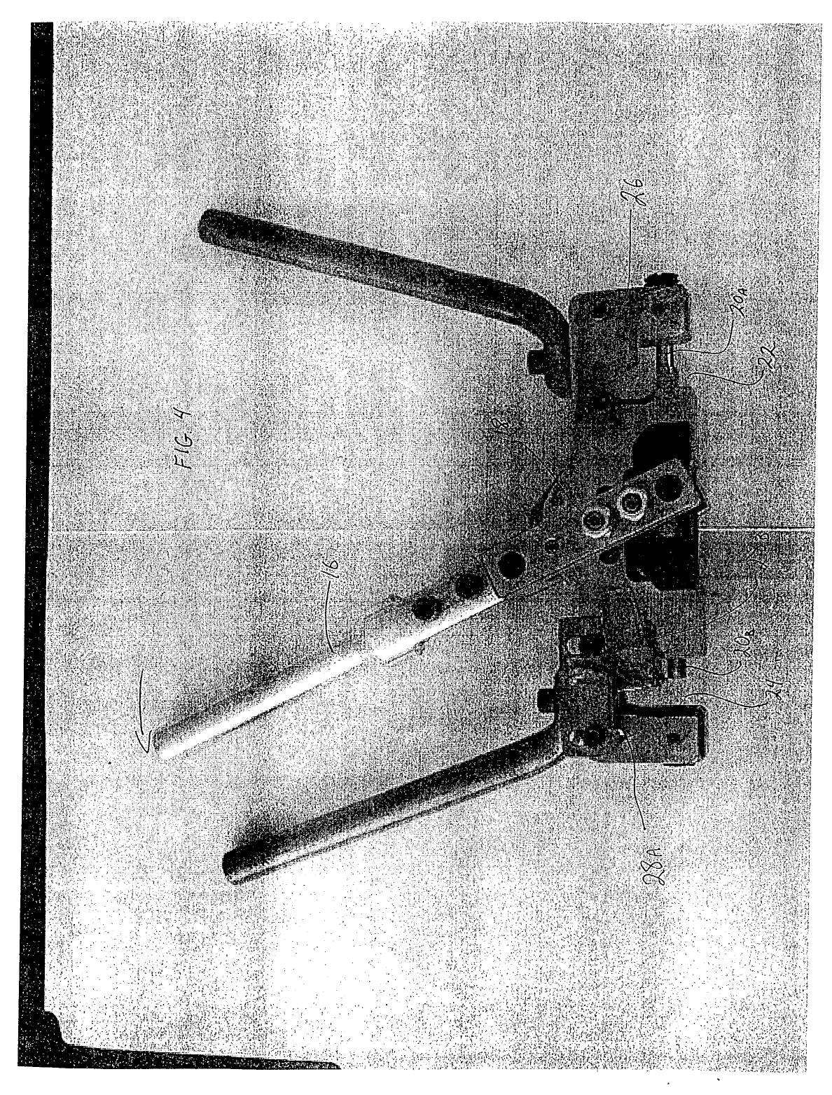

As shown in FIGS. 3 and 4, openings 22 and 24 can include adjustable positioning elements or spacers 26 and 28a, 28b. Positioning elements 26 and 28 are adjusted by the user based on the particular gutter being punched and are adapted to not only to provide a reproducible positioning of the tool over the gutter, but also serve to prevent the tool from damaging the gutter surface during use. The positioning elements 26 and 28 are preferably made of a softer material than the body 10, such as for example, plastic, polyvinylchloride (pvc) or any other suitably smooth yet strong material.

Once adjusted for a particular gutter being worked with, subsequent adjustment of the tool's positioning elements 26 and 28 will not be necessary. The positioning elements 26 and 28 enable punch 10 to be repeatedly and precisely positioned over the water collecting opening of the gutter such that the punched holes are perfectly aligned with each other substantially transverse to the water collecting pending. Gutter punch 10 will, by design, axially align the front and rear punched holes so that when the gutter fastener (with furrow) is passed through the punched holes, the fastener is perfectly positioned transverse to the water collecting opening and thereby provides the greatest strength in the fastening installation.

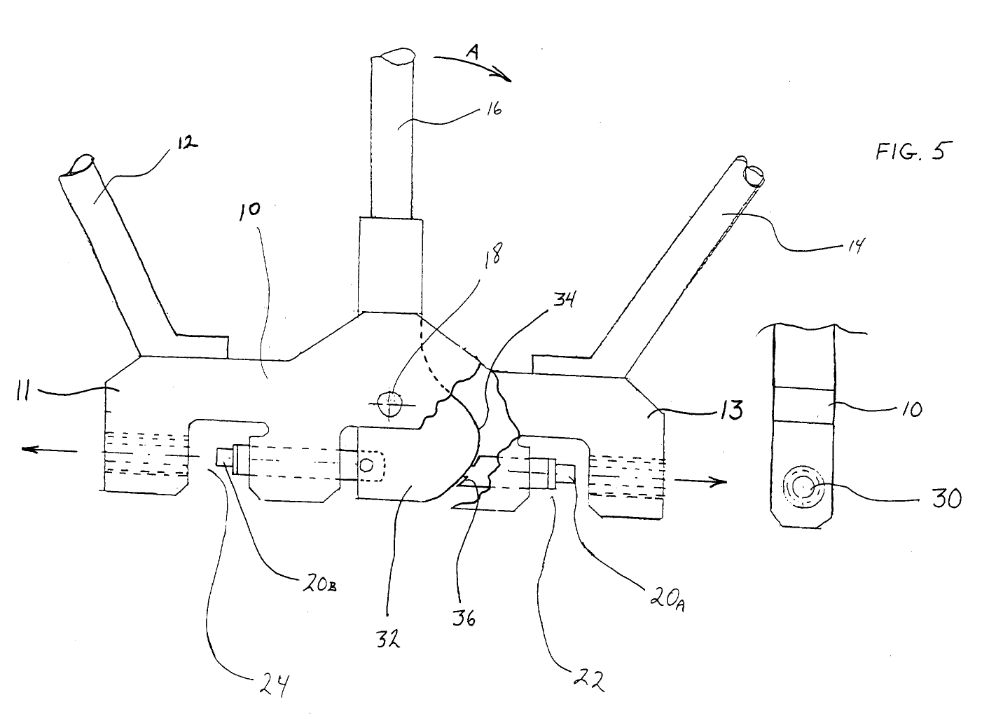

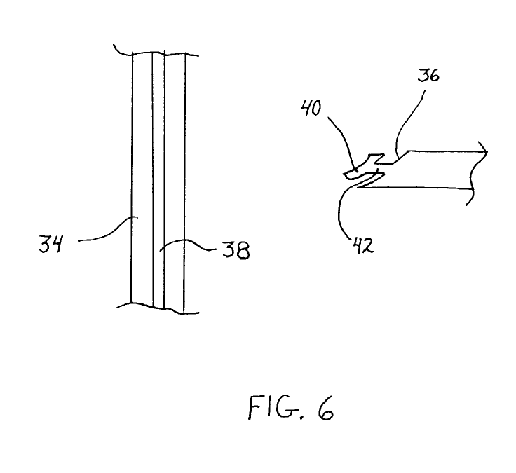

According to the embodiment of FIGS. 1-4, a double throw punching device has been disclosed. FIGS. 5 and 6 show another embodiment of the gutter punch 10 incorporating a single throw design. As shown in FIG. 5, throw arm 16 can include a cam-like end 32 with an eccentric surface or rail 34. The punch 20a is slidably connected to the eccentric surface 34 such that when throw arm 16 is moved in the position indicated by arrow A, punch 20b is axially moved to engage and punch the rear of the gutter, while at the same time punch 20s rides the eccentric curve 34 and at a predetermined point on the curve engages and punches the front of the gutter. In this embodiment, the timing of the actually punching (i.e., front and rear) is such that one occurs before the other, or sequential. The reason for such sequential punching is to relieve strain on the tool and to make it easier for the operator of the tool.

FIG. 6 shows a front view of the curved surface 34 having a slot 38 disposed therein. The end of punch 20a includes a stem 42 that extends from a curved surface 36 and a flared tab portion 40 connected to the stem 42. During operation, the stem 42 rides within slot 38 such that tab portion 40 is inside lower portion 32 of throw arm 16 and the surface 36 rides along curved surface 34 of the throw arm. Those of ordinary skill in the art will recognize that other methods for slidably connected punch 20a to the lower end of 32 of throw arm 16 can be employed without departing from the spirit of the invention.

Once a punching operation is complete, the entire gutter punch tool can be slid along the length of the gutter to the next punching location. The preferred disposition of the punch holes is dependent on the length of the gutter being fastened, but should not exceed 3 feet in accordance with the standards set by the Sheet Metal & Air Conditioning Contractors National Association (SMACNA) Architectural Sheet Metal Manual Fifth Edition.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. A gutter punch device for punching fastener pilot holes in the front and rear of a gutter, the punch device comprising:
a body having a front gutter receiving opening and a rear gutter receiving opening;
a throw arm pivotally connected to said body and having an upper end and a lower end;
a front punch connected to said lower end of said throw arm and extending into said front gutter receiving opening; and
a rear punch connected to said lower end of said throw arm and extending into said front gutter receiving opening;
wherein movement of said throw arm causes at least one of said front punch and said rear punch to engage and punch a hole in the gutter disposed in the respective gutter receiving opening.

2. The gutter punch device according to claim 1, wherein movement of said throw arm in a first direction causes one of said front punch and said rear punch to punch a hole in the gutter disposed in the respective gutter receiving opening.

3. The gutter punch device according to claim 1, wherein movement of said throw arm in one direction causes said front punch and said rear punch to punch a hole in the gutter disposed in the respective gutter receiving opening, wherein the front and rear punched holes are axially aligned with each other.

4. The gutter punch device according to claim 1, wherein said throw arm is moved a second opposing direction to cause the other of said front punch and said rear punch to punch a hole in the gutter disposed in the respective gutter receiving opening.

5. The gutter punch device according to claim 1, wherein said gutter receiving openings further comprise adjustable positioning elements connected to said body, wherein said positioning elements aide in positioning the gutter in the gutter receiving openings and preventing damage to the gutter when disposed in said gutter receiving openings.

6. The gutter punch device according to claim 1, further comprising at least one handle connected to said body.

7. The gutter punch device according to claim 1, wherein said body further comprises at waste port axially aligned with and opposed to each of said front and rear punches for enabling a punched portion of the gutter to be discarded from the gutter punch after a punching operation.

8. The gutter punch according to claim 3, wherein said lower end of said throw arm comprises an eccentric curved surface and one of said front punch and rear punch is slidably connected to said eccentric curved surface such that movement of said throw arm in a direction opposite said curved surface simultaneously actuates said front punch and said rear punch.

9. The gutter punch device according to claim 7, wherein said eccentric curved surface is such that the simultaneous actuation of said front and rear punches results in a sequential punching action to the front and rear of the gutter disposed in the front and rear gutter receiving openings.

10. A gutter punch device for punching fastener pilot holes in the front and rear of a gutter, the punch device comprising:
a body having at least one gutter receiving opening;
a throw arm pivotally connected the body; and
at least one punch connected to said throw arm and slidably disposed in said body, said at least one punch being selectively extended into said gutter receiving opening and adapted to engage and punch a gutter positioned in said opening in response to movement of said throw arm.

11. The gutter punch according to claim 10, wherein said at least one gutter receiving opening further comprises a front gutter receiving opening and a rear gutter receiving opening.

12. The gutter punch device according to claim 10, further comprising adjustable positioning elements connected to said body, wherein said positioning elements for positioning the gutter within the at least one gutter receiving opening, and preventing damage to the gutter when disposed in said at least one gutter receiving opening.

13. The gutter punch device according to claim 10, wherein said at least one punch comprises a front punch and a rear punch, wherein movement of said throw arm in a first direction actuates one of said punches.

14. The gutter punch device according to claim 13, wherein movement of said throw arm in a second direction actuates the other of said punches.

15. The gutter punch device according to claim 10, wherein said at least one punch comprises a front punch and a rear punch, wherein movement of said throw arm in one direction actuates both of said punches.
